(19) United States
(12) Patent Application Publication
(10) Pub. No.: US 2025/0300559 A1
(43) Pub. Date: Sep. 25, 2025

(54) SYSTEMS AND METHODS FOR TRAVERSING NON-LINEARITY OF A MODE BOUNDARY OF A POWER CONVERTER

(71) Applicant: Cirrus Logic International Semiconductor Ltd., Edinburgh (GB)

(72) Inventors: Siddharth MARU, Austin, TX (US); Hasnain AKRAM, Austin, TX (US); Graeme G. MACKAY, Austin, TX (US)

(73) Assignee: Cirrus Logic International Semiconductor Ltd., Edinburgh (GB)

(21) Appl. No.: 19/065,429

(22) Filed: Feb. 27, 2025

Related U.S. Application Data
(60) Provisional application No. 63/568,972, filed on Mar. 22, 2024.

(51) Int. Cl. H02M 3/158; H02M 3/00

(52) U.S. Cl. CPC H02M 3/158; H02M 3/01

(57) ABSTRACT

A method for seamlessly traversing a non-linearity on a mode transition boundary of a power converter capable of operating in at least two distinct modes with distinct switching configurations may include maintaining a volt-second balance for the power converter across the mode transition boundary and maintaining an approximate capacitor charge balance for the power converter across the mode transition boundary.

### RELATED APPLICATION

The present disclosure claims priority to U.S. Provisional Patent Application No. 63/568,972, filed Mar. 22, 2024, which is incorporated by reference herein in its entirety.

### FIELD OF DISCLOSURE

The present disclosure relates in general to circuits for electronic devices, including without limitation personal audio devices such as wireless telephones and media players, and more specifically, systems and methods for traversing a non-linearity of a mode boundary of a power converter.

### BACKGROUND

Personal audio devices, including wireless telephones, such as mobile/cellular telephones, cordless telephones, mp3 players, and other consumer audio devices, are in widespread use. Such personal audio devices may include circuitry for driving a pair of headphones, one or more speakers, haptic actuators, camera stabilization motors, and/or other loads. Such circuitry often includes a driver including a power amplifier for driving an output signal to such loads. Oftentimes, a power converter may be used to provide a supply voltage to a power amplifier in order to amplify a signal driven to speakers, headphones, other transducers, or other loads. A switching power converter is a type of electronic circuit that converts a source of power from one direct current (DC) voltage level to another DC voltage level. Examples of such switching DC-DC converters include but are not limited to a boost converter, a buck converter, a buck-boost converter, an inverting buck-boost converter, and other types of switching DC-DC converters. Thus, using a power converter, a DC voltage such as that provided by a battery may be converted to another DC voltage used to power the power amplifier. A power converter may be used to provide supply voltage rails to one or more components in a device. A power converter may also be used in other applications besides driving audio transducers, such as driving haptic actuators or other electrical or electronic loads. Further, a power converter may also be used in charging a battery from a source of electrical energy (e.g., an AC-to-DC adapter), oftentimes as part of a power management integrated circuit (PMIC).

In applications in which the output and input voltages of a power converter may be expected to be close to one another, a four-switch buck-boost converter is often used. Use of a four-switch buck-boost converter may enable operating in a buck-boost mode when output voltage is close to input voltage and shifting to buck or boost modes when the output voltage is sufficiently separated from the input to improve efficiency.

The operation in buck-boost mode and transition into and out of buck-boost mode from the buck and boost modes may cause non-linearities in operation that may lead to ripple on the output voltage. In addition, a smooth transition into and out of buck-boost mode may be critical to minimize discontinuity on the output voltage. Further, continuous operation in the buck-boost mode at all times may not be an option to due negative impacts on efficiency.

In addition to buck-boost converters, other power converters may include similar non-linearities across mode boundaries.

### SUMMARY

In accordance with the teachings of the present disclosure, one or more disadvantages and problems associated with operation of power converters may be reduced or eliminated.

In accordance with embodiments of the present disclosure, a method for seamlessly traversing a non-linearity on a mode transition boundary of a power converter capable of operating in at least two distinct modes with distinct switching configurations may include maintaining a volt-second balance for the power converter across the mode transition boundary and maintaining an approximate capacitor charge balance for the power converter across the mode transition boundary.

In accordance with these and other embodiments of the present disclosure, a system may include a power converter capable of operating in at least two distinct modes with distinct switching configurations and control circuitry configured to seamlessly traverse a non-linearity on a mode transition boundary of the power converter by maintaining a volt-second balance for the power converter across the mode transition boundary and maintaining an approximate capacitor charge balance for the power converter across the mode transition boundary.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a circuit diagram of selected components of an example buck-boost power converter, in accordance with embodiments of the present disclosure;

FIG. 2 illustrates a block diagram of selected components of an example system for driving a load using a power converter, in accordance with embodiments of the present disclosure;

FIGS. 3A-3C illustrate operation of the example buck-boost power converter depicted in FIG. 1, in accordance with embodiments of the present disclosure;

FIG. 4 illustrates example carrier wave signals for use by a modulator to generate switch control signals, in accordance with embodiments of the present disclosure;

FIG. 5 illustrates example carrier wave signals and control signals generated therefrom by a modulator for a particular value for a reference signal, in accordance with embodiments of the present disclosure;

FIG. 6A illustrates an example current waveform for an inductor current through a power inductor of a power converter with two magnetization phases, in accordance with embodiments of the present disclosure;

FIG. 6B illustrates an example current waveform for an inductor current through a power inductor of a power converter with two demagnetization phases, in accordance with embodiments of the present disclosure;

FIG. 6C illustrates an example current waveform for an inductor current through a power inductor of a power converter over two switching cycles, in accordance with embodiments of the present disclosure;

FIG. 7 illustrates example components of an example modulator, in accordance with embodiments of the present disclosure;

FIG. 8 illustrates waveforms of an example mapping of a reference signal into two control variables for conversion into switch control signals, in accordance with embodiments of the present disclosure;

FIG. 9 illustrates example components of an example modulator, in accordance with embodiments of the present disclosure;

FIG. 10 illustrates example piecewise carrier wave signals for use by a modulator to generate switch control signals, in accordance with embodiments of the present disclosure;

FIG. 11A illustrates example carrier wave signals for use by a modulator to generate intermediate switch control signals, in accordance with embodiments of the present disclosure; and

FIG. 11B illustrates example additional carrier wave signals for use by a modulator to generate intermediate switch control signals, in accordance with embodiments of the present disclosure.

### DETAILED DESCRIPTION

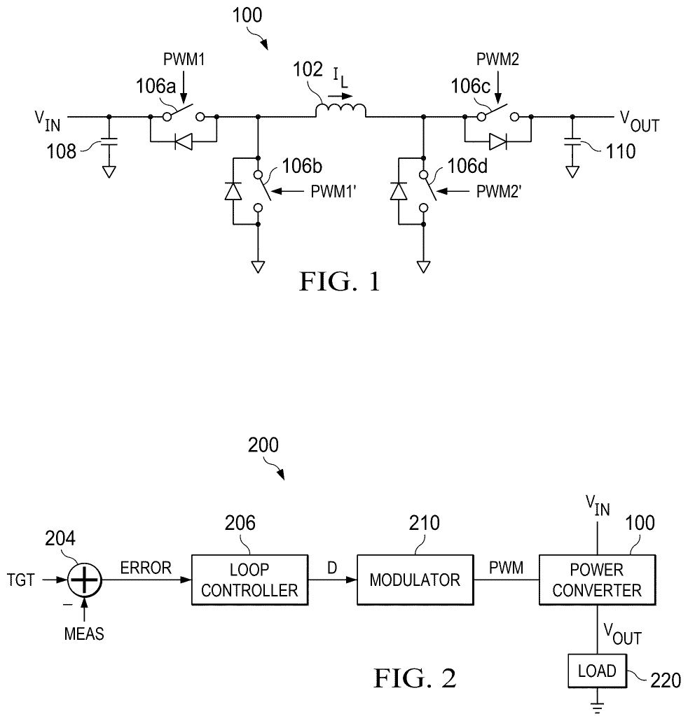

FIG. 1 illustrates a circuit diagram of selected components of an example buck-boost power converter 100, in accordance with embodiments of the present disclosure. As shown in FIG. 1, buck-boost power converter 100 may receive an input voltage V_{IN} on an input capacitor 108 and have an output configured to generate an output voltage V_{OUT} on an output capacitor 110 based on switching signals PWM1 and PWM2, which may comprise pulse-width modulation signals. Buck-boost power converter 100 may also include a power inductor 102. In addition, buck-boost power converter 100 may include a plurality of switches 106a, 106b, 106c, and 106d, wherein switch 106a is coupled between the input and a first terminal of power inductor 102, switch 106b is coupled between the first terminal of power inductor 102 and a ground voltage, switch 106c is coupled between the output and a second terminal of power inductor 102, and switch 106d is coupled between the second terminal of power inductor 102 and the ground voltage. In operation, switch 106a may be controlled by control signal PWM1, switch 106b may be controlled by a complement of control signal PWM1 (e.g., PWM1′), switch 106c may be controlled by control signal PWM2, and switch 106d may be controlled by a complement of control signal PWM2 (e.g., PWM2′) in order to drive a power inductor current I_{L} through power inductor 102 to regulate output voltage V_{OUT} to a desired target voltage.

FIG. 2 illustrates a block diagram of selected components of an example system 200 for driving a load 220 using power converter 100, in accordance with embodiments of the present disclosure. As shown in FIG. 2, system 200 may include power converter 100, signal combiner 204, loop controller 206, modulator 210, and load 220. In some embodiments, system 200 depicted in FIG. 2 may use a power converter other than power converter 100 depicted in FIG. 1.

Signal combiner 204 may comprise any suitable system, device, or apparatus configured to calculate an error signal ERROR equal to the difference between a target signal TGT and a measured feedback signal MEAS. Target signal TGT may represent a target or desired value for any physical quantity within system 200, including without limitation output voltage V_{OUT}. Likewise, measured feedback signal MEAS may comprise a measured value of such physical quantity (e.g., a measured value for output voltage V_{OUT}). For purposes of clarity and exposition, circuitry for measuring measured feedback signal MEAS is not shown in FIG. 2; however, system 200 may include such circuitry and those of skill in the art would readily have knowledge of how to implement such circuitry to measure measured feedback signal MEAS.

Loop controller 206 may comprise any system, device, or apparatus configured to implement a control loop to regulate measured feedback signal MEAS to track target signal TGT. For example, based on error signal ERROR, loop controller 206 may generate a reference signal D. Such reference signal D may represent, for example, a commanded duty cycle for power converter 100 to cause regulation of measured feedback signal MEAS to track target signal TGT. Loop controller 206 may be implemented with a proportional (P) controller, proportional-integral (PI) controller, proportional-differential (PD) controller, proportional-integral-differential (PID) controller, or any other suitable controller.

Modulator 210 may comprise any suitable system, device, or apparatus configured to receive reference signal D, and generate switching signals PWM1 and PWM2 for controlling switching of switches of power converter 100. In some embodiments, modulator 210 may comprise a pulse-width modulator.

Load 220 may include any appropriate electrical or electronic load that may be powered from power converter 100, including without limitation a rechargeable battery.

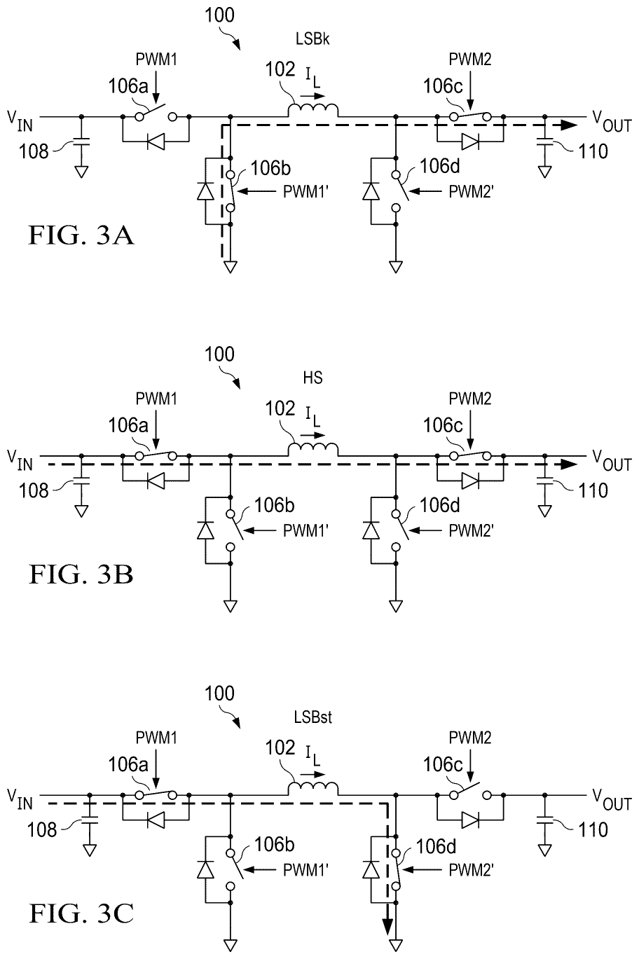

In operation, switches 106 may be controlled by modulator 210 to regulate output voltage V_{OUT} to a desired target voltage. As shown in FIGS. 3A-3C, operation of power converter 100 may include cyclic, periodic commutation of switches 106 among a low-side buck state LSBk (shown in FIG. 3A), a high-side state HS (shown in FIG. 3B), and a low-side boost-state LSBst (shown in FIG. 3C).

For example, as shown in FIG. 3A, in low-side buck state LSBk, switches 106b and 106c may be activated (and switches 106a and 106d deactivated), such that current flows from ground voltage to the output of power converter 100 through switch 106b, power inductor 102, and switch 106c. As another example, as shown in FIG. 3B, in high-side buck state HS, switches 106a and 106c may be activated (and switches 106b and 106d deactivated), such that current flows from the input to the output of power converter 100 through switch 106a, power inductor 102, and switch 106c. As a further example, as shown in FIG. 3C, in low-side boost state LSBst, switches 106a and 106d may be activated (and switches 106b and 106c deactivated), such that current flows from the input of power converter 100 to ground voltage through switch 106a, power inductor 102, and switch 106d.

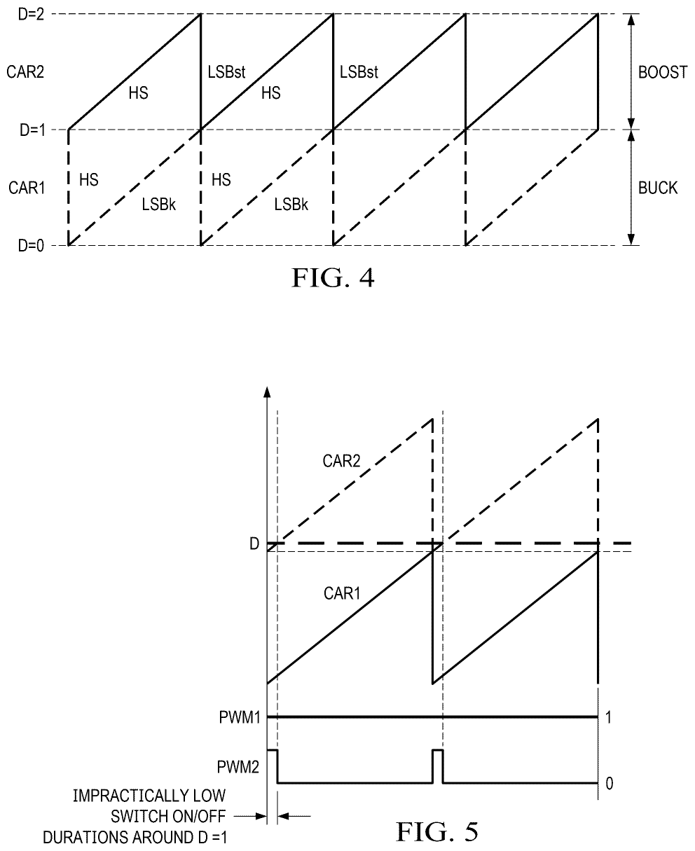

FIG. 4 illustrates example carrier wave signals CAR1 and CAR2 for use by modulator 210 to generate switch control signals PWM1 and PWM2, in accordance with embodiments of the present disclosure. Although FIG. 4 shows carrier signals CAR1 and CAR2 as sawtooth waves, it is understood that carrier signals CAR1 and CAR2 may comprise any suitable waveform (e.g., triangle wave). As depicted in FIG. 4, modulator 210 may compare reference signal D to each of CAR1 and CAR2 and based on the comparison, generate appropriate control signals PWM1 and PWM2 to cause switches 106 of power converter 100 to switch into a particular switch state. For example, when reference signal D is less than carrier signal CAR1 and carrier signal CAR2, modulator 210 may generate control signals PWM1 and PWM2 to cause switches 106 of power converter 100 to operate in low-side buck state LSBk. As another example, when reference signal D is greater than carrier signal CAR1 and less than carrier signal CAR2, modulator 210 may generate control signals PWM1 and PWM2 to cause switches 106 of power converter 100 to operate in high-side state HS. As a further example, when reference signal D is greater than carrier signal CAR1 and carrier signal CAR2, modulator 210 may generate control signals PWM1 and PWM2 to cause switches 106 of power converter 100 to operate in low-side boost state LSBst.

However, the modulation scheme shown in FIG. 4 may have disadvantages. FIG. 5 illustrates example carrier wave signals CAR1 and CAR2 (e.g., identical to those in FIG. 4) and control signals PWM1 and PWM2 generated therefrom by modulator 210 for a particular value of reference signal D near D=1, in accordance with embodiments of the present disclosure. As shown in FIG. 5, values of reference signal D near D=1 may lead to impractically short switch times which may not be supported by the process technology of switches 106 or other components of power converter 100 and/or system 200. Accordingly, modulation schemes for modulator 210 in which switching times are practically achievable, while also maintaining volt-second balance of power converter 100 and capacitor charge balance of capacitors 108 and 110 across the D=1 transition boundary may be desirable.

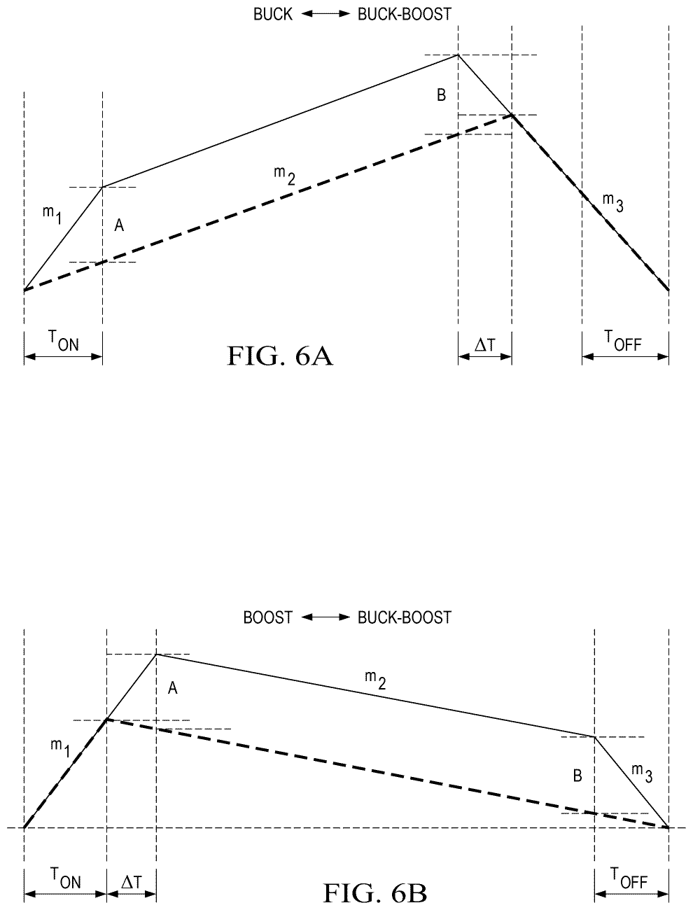

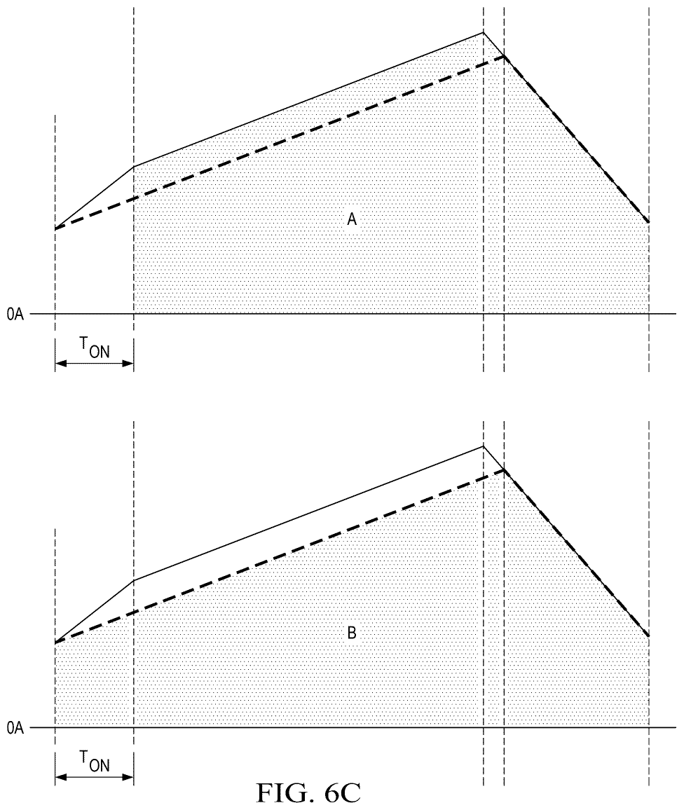

FIG. 6A illustrates an example current waveform for power inductor current I_{L} through power inductor 102 of power converter 100 with two magnetization phases in a transition between buck and buck-boost operation, in accordance with embodiments of the present disclosure. As shown in FIG. 6A, as opposed to the single magnetization phase/single demagnetization phase operation (with slopes m₂ and m₃ respectively for power inductor current I_{L}) of power converter 100 that may occur with the modulation scheme with the carrier waves of FIG. 4, FIG. 6A depicts two magnetization phases, one with a slope of m₁ for power inductor current I_{L} and another with a slope of m₂ for power inductor current I_{L}, followed by a demagnetization phase with slope m₃ for power inductor current I_{L}. In such operation, there may exist a difference A in power inductor current I_{L} at the end of a period of time Tₒₙ of the first magnetization phase in two-magnetization phase operation, as compared to at the end of the same period of time in single-magnetization phase operation. Likewise, there may exist a difference B in power inductor current I_{L} at its peak current value in two-magnetization phase operation as compared to its peak current in single-magnetization phase operation. In addition, there may be a difference in time ΔT at which the peak current value is reached in two-magnetization phase operation as compared to single-magnetization phase operation.

$$Given that A = B , then :$$

$${m}_{1} {T}_{on} - {m}_{2} {T}_{on} = {m}_{3} Δ T + {m}_{2} Δ T$$

$$Δ T = \frac{{T}_{on} ( {m}_{1} - {m}_{2} )}{( {m}_{2} + {m}_{3} )}$$

$$where {m}_{1} = \frac{{V}_{in}}{L} , {m}_{2} = \frac{{V}_{in} - {V}_{out}}{L} , {m}_{3} = \frac{{V}_{out}}{L} . Accordingly :$$

$$Δ T = {T}_{on} ( \frac{{V}_{out}}{{V}_{in}} ) = D {T}_{on} .$$

FIG. 6B illustrates an example current waveform for power inductor current I_{L} through power inductor 102 of power converter 100 with two demagnetization phases in a transition between boost and buck-boost operation, in accordance with embodiments of the present disclosure. As shown in FIG. 6B, as opposed to the single magnetization phase/single demagnetization phase operation (with slopes m₁ and m₂ respectively for power inductor current I_{L}) of power converter 100 that may occur with the modulation scheme with the carrier waves of FIG. 4, FIG. 6B depicts two demagnetization phases, one with a slope of m₂ for power inductor current I_{L} and another with a slope of m₃ for power inductor current I_{L}, both preceded by a magnetization phase with slope m₁ for power inductor current I_{L}. In such operation, there may exist a difference A between power inductor current I_{L} at its peak current value in two-demagnetization phase operation as compared to its peak current in single-demagnetization phase operation. Likewise, there may exist a difference B in power inductor current I_{L} at a period of time T_{off} prior to the end of magnetization, in which time T_{off} may represent a duration of time of the second demagnetization phase in two-demagnetization phase operation. In addition, the magnetization phase during the single-demagnetization phase operation may occur over a period of time Tₒₙ, and there may exist a difference in time ΔT between duration of the magnetization phase in two-magnetization phase operation as compared to the duration of the magnetization time in single-magnetization phase operation.

$$Given that A = B , then :$$

$${m}_{3} {T}_{off} - {m}_{2} {T}_{off} = {m}_{1} Δ T + {m}_{2} Δ T$$

$$Δ T = \frac{{T}_{off} ( {m}_{3} - {m}_{2} )}{( {m}_{2} + {m}_{1} )}$$

$$where {m}_{1} = \frac{{V}_{in}}{L} , {m}_{2} = \frac{{V}_{in} - {V}_{out}}{L} , {m}_{3} = \frac{{V}_{out}}{L} . Accordingly :$$

$$Δ T = {T}_{off} ( \frac{{V}_{in}}{{V}_{out}} ) = ( 1 - D ) {T}_{off} .$$

The foregoing two-magnetization phase operation and two-magnetization phase operation for power inductor current I_{L} may thus achieve volt-second balance and minimize discontinuity between mode transitions of power converter 100.

While the approach described above with FIG. 6B may achieve volt-second balance across mode transitions of power converter 100, it may not achieve capacitance-charge balance (i.e., the amount of energy pushed at the buck/buck-boost boundary and/or the boost/buck-boost boundary may not match). This may occur because such approach may attempt to add the smallest possible durations for low-side buck state LSBk and low-side boost state LSBst. However, there may exist durations for low-side buck state LSBk and low-side boost state LSBst which may not only maintain volt-second balance but also minimize capacitance-charge imbalance. Such durations may be estimated as a function of input voltage V_{IN} and output voltage V_{OUT}. For example, referring to FIG. 6C, period of time Tₒₙ may be calculated to ensure that the shaded area A in the left-side waveform of a switching cycle is equal to the shaded area B in the right-side waveform of a subsequent switching cycle to ensure capacitor-charge balance. Also, period of time Tₒₙ may be calculated to ensure volt-second balance acts as a lower limit on the allowed on-time.

Accordingly, modulator 210 may be configured to generate control signals PWM1 and PWM2 in order to generate the power inductor current waveforms as described above.

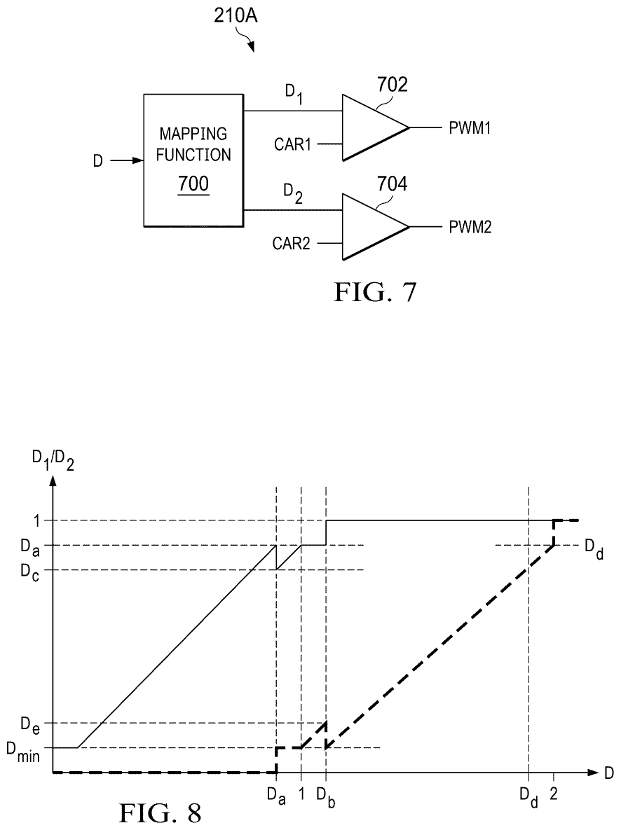

FIG. 7 illustrates example components of an example modulator 210A that may generate such power inductor current waveforms, in accordance with embodiments of the present disclosure. Modulator 210A may be used to implement modulator 210. As shown in FIG. 7, modulator 210A may implement a mapping function 700 that maps reference signal D to control variables D₁ and D₂. Such control variables D₁ and D₂ may respectively be compared by comparators 702 and 704 to carrier signals CAR1 and CAR2 (e.g., which may be equivalent to carrier signals CAR1 and CAR2 shown in FIG. 4), with control signals PWM1 and PWM2 generated based on the comparisons. For purposes of clarity and exposition, signal generators for generating carrier signals CAR1 and CAR2 are not shown in FIG. 7. However, it is understood that modulator 210 may include such signal generators.

FIG. 8 illustrates waveforms of an example mapping of reference signal D into control variables D₁ and D₂, in accordance with embodiments of the present disclosure. As shown in FIG. 8, control variables D₁ and D₂ may each be a function of reference signal D, with piecewise linear sections near transition regions of reference signal D, in order to minimize or eliminate non-linearities between mode transitions of power converter 100. For example, as shown in the example mappings of FIG. 8, between values of reference signal D near zero to a value of Dₐ, control variable D₁ may increase linearly from a value Dₘᵢₙ to value Dₐ. Between values of reference signal D between value Dₐ and 1, control variable D₁ may increase linearly from a value D_{c} to value Dₐ. Between values of reference signal D between 1 and value D_{b}, control variable D₁ may remain constant at value Dₐ. Between values of reference signal D between value D_{b} and 2, control variable D₁ may remain constant at 1.

Similarly, control variable D₂ may have a similar mapping. In FIG. 8, the mapping of control variable D₂ is shown without its offset of its minimum value (e.g., 1). Thus, between values of reference signal D of 0 to a value of Dₐ, control variable D₂ may remain constant at 1. Between values of reference signal D between value Dₐ and 1, control variable D₂ may remain constant at a value 1+Dₘᵢₙ. Between values of reference signal D between 1 and value D_{b}, control variable D₂ may linearly increase from value 1+Dₘᵢₙ to a value 1+Dₑ. Between values of reference signal D between value D_{b} and 2, control variable D₂ may increase linearly from value 1+D_{b} to a value 1+Dₐ less than 2. For values of reference signal D above 2, control variable D₂ may remain constant at 2.

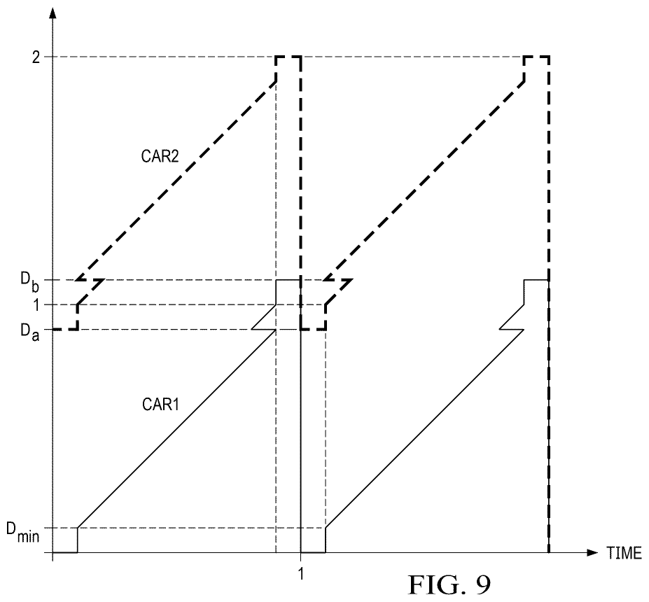

Alternatively to generating two control variables D₁ and D₂ based on reference signal D, piecewise linear carrier signals may be used. FIG. 9 illustrates example piecewise carrier wave signals CAR1 and CAR2 for use by modulator 210 to generate switch control signals PWM1 and PWM2, in accordance with embodiments of the present disclosure. However, as seen in FIG. 9, such approach includes non-causal values of carrier wave signals CAR1 and CAR2 (i.e., carrier signals CAR1 and CAR2 may not be a mathematical function of time, given that at certain portions of their curves, carrier signals CAR1 and CAR2 may have more than one value at a given time).

To overcome such disadvantage, carrier wave signals CAR1 and CAR2 may each effectively be split into two carrier signals and fed to different comparators, with outputs of such comparators combined to generate control signals PWM1 and PWM2, as described in greater detail below.

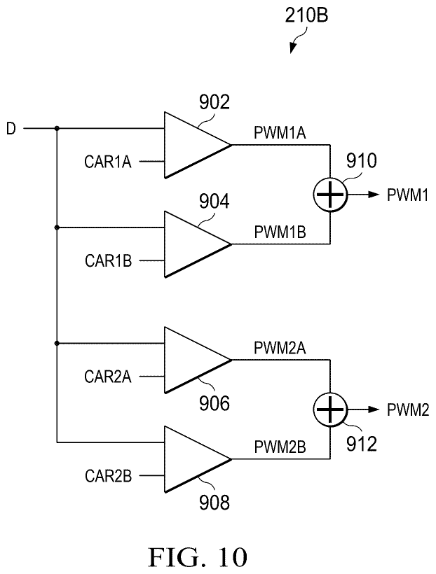

FIG. 10 illustrates example components of an example modulator 210B, in accordance with embodiments of the present disclosure. Modulator 210B may be used to implement modulator 210. As shown in FIG. 10, modulator 210B may include a comparator 902 to compare reference signal D to a carrier signal CAR1A to generate an intermediate control signal PWM1A, a comparator 904 to compare reference signal D to a carrier signal CAR1B to generate an intermediate control signal PWM1B, a comparator 906 to compare reference signal D to a carrier signal CAR2A to generate an intermediate control signal PWM2A, and a comparator 908 to compare reference signal D to a carrier signal CAR2B to generate an intermediate control signal PWM2B. Further, modulator 210B may include a signal combiner 910 configured to combine intermediate control signal PWM1A and intermediate control signal PWM1B to generate control signal PWM1, and a signal combiner 912 configured to combine intermediate control signal PWM2A and intermediate control signal PWM2B to generate control signal PWM2. For purposes of clarity and exposition, signal generators for generating carrier signals CAR1A, CAR1B, CAR2A, and CAR2B are not shown in FIG. 10. However, it is understood that modulator 210B may include such signal generators.

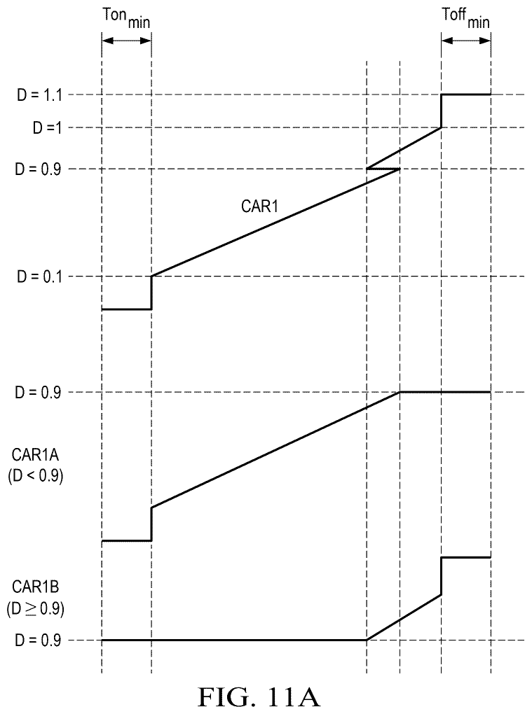

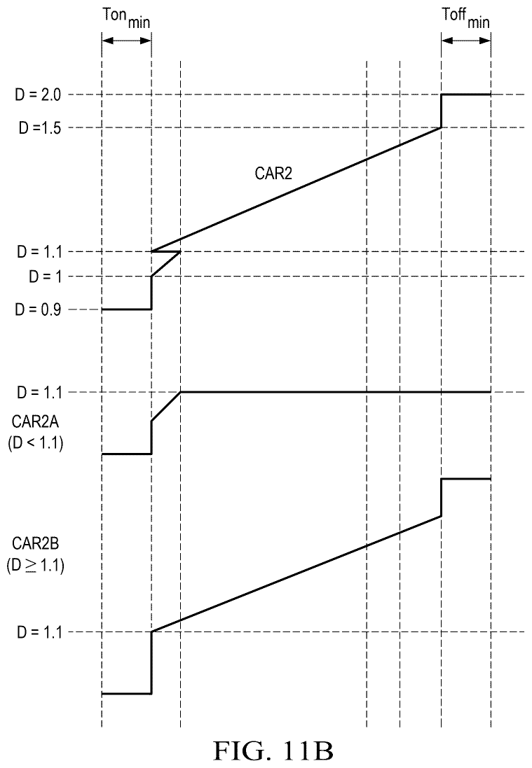

FIG. 11A illustrates example carrier wave signals CAR1A and CAR1B for use by modulator 210B to generate intermediate switch control signals PWM1A and PWM1B, in accordance with embodiments of the present disclosure. As shown in FIG. 11A, carrier signal CAR1A may only be applicable for values of reference signal D less than a threshold value (e.g., 0.9) while carrier signal CAR1B may only be applicable for values of reference signal D greater than or equal to such threshold value. As a result, comparison of reference signal D to carrier signals CAR1A and CAR1B to generate intermediate switch control signals PWM1A and PWM1B, and the subsequent summation of intermediate switch control signals PWM1A and PWM1B to generate control signal PWM1 may result in the same practical effect as comparing reference signal D to non-causal carrier signal CAR1 shown in FIG. 9.

Similarly, FIG. 11B illustrates example carrier wave signals CAR2A and CAR2B for use by modulator 210B to generate intermediate switch control signals PWM2A and PWM2B, in accordance with embodiments of the present disclosure. As shown in FIG. 11B, carrier signal CAR2A may only be applicable for values of reference signal D less than a threshold value (e.g., 1.1) while carrier signal CAR2B may only be applicable for values of reference signal D greater than or equal to such threshold value. As a result, comparison of reference signal D to carrier signals CAR2A and CAR2B to generate intermediate switch control signals PWM2A and PWM2B, and the subsequent summation of intermediate switch control signals PWM2A and PWM2B to generate control signal PWM2 may result in the same practical effect as comparing reference signal D to non-causal carrier signal CAR2 shown in FIG. 9.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A method for seamlessly traversing a non-linearity on a mode transition boundary of a power converter capable of operating in at least two distinct modes with distinct switching configurations, comprising:
maintaining a volt-second balance for the power converter across the mode transition boundary; and
maintaining an approximate capacitor charge balance for the power converter across the mode transition boundary.

2. The Method of claim 1, wherein maintaining the volt-second balance and maintaining the approximate capacitor charge balance further comprises using a digital pulse-width modulation scheme that generates one or more switch control signals for switching switches of the power converter among the switching configurations.

3. The method of claim 2, wherein using the digital pulse-width modulation scheme comprises:
mapping a primary control value for controlling the power converter into a first control variable and a second control variable;
comparing the first control variable to a first pulse-width modulation carrier to generate a first switch control signal of the one or more switch control signals; and
comparing the second control variable to a second pulse-width modulation carrier to generate a second switch control signal of the one or more switch control signals.

4. The method of claim 3, wherein the primary control variable is representative of a duty cycle of the power converter.

5. The method of claim 4, wherein:
the first switch control signal is a first duty cycle for one or more first switches of the power converter; and
the second switch control signal is a second duty cycle for one or more second switches of the power converter.

6. The method of claim 5, wherein:
the one or more first switches comprise a first set of complementary switches; and
the one or more second switches comprise a second set of complementary switches.

7. The method of claim 6, further comprising dynamically modifying the first duty cycle and the second duty cycle around the mode transition boundary to ensure one or more of:
a volt-second balance for the power converter across the mode transition boundary;
a capacitor charge balance for the power converter across the mode transition boundary; and
practically realizable switching times for switches of the power converter.

8. The method of claim 7, wherein dynamically modifying the first duty cycle and the second duty cycle comprises making non-linear modifications to the first duty cycle and the second duty cycle.

9. The method of claim 8, wherein dynamically modifying the first duty cycle and the second duty cycle comprises making step adjustments to the first duty cycle and the second duty cycle.

10. The method of claim 8, wherein dynamically modifying the first duty cycle and the second duty cycle results in introduction of an additional switching phase during a switching cycle of the power converter.

11. The method of claim 3, wherein:
the first pulse-width modulation carrier is piecewise linear; and
the second pulse-width modulation carrier is piecewise linear.

12. The method of claim 11, wherein:
the first pulse-width modulation carrier has step discontinuities; and
the second pulse-width modulation carrier has step discontinuities.

13. The method of claim 12, wherein:
the first pulse-width modulation carrier is a combination of a first set of multiple individual linear sections; and
the second pulse-width modulation carrier is a combination of a second set of multiple individual linear sections.

14. The method of claim 1, wherein the non-linearity is traversed while maintaining on and off times of switches of the power converter above a pre-determined threshold.

15. The method of claim 1, wherein the power converter is a buck-boost converter.

16. The method of claim 15, wherein the seamless transition occurs across the buck-boost mode boundary by introducing an additional switching phase to a switching cycle of the power converter.

17. A system comprising:
a power converter capable of operating in at least two distinct modes with distinct switching configurations; and
control circuitry configured to seamlessly traverse a non-linearity on a mode transition boundary of the power converter by:
maintaining a volt-second balance for the power converter across the mode transition boundary; and
maintaining an approximate capacitor charge balance for the power converter across the mode transition boundary.

18. The system of claim 17, wherein maintaining the volt-second balance and maintaining the approximate capacitor charge balance further comprises using a digital pulse-width modulation scheme that generates one or more switch control signals for switching switches of the power converter among the switching configurations.

19. The system of claim 18, wherein using the digital pulse-width modulation scheme comprises:
mapping a primary control value for controlling the power converter into a first control variable and a second control variable;
comparing the first control variable to a first pulse-width modulation carrier to generate a first switch control signal of the one or more switch control signals; and
comparing the second control variable to a second pulse-width modulation carrier to generate a second switch control signal of the one or more switch control signals.

20. The system of claim 19, wherein the primary control variable is representative of a duty cycle of the power converter.

21. The system of claim 20, wherein:
the first switch control signal is a first duty cycle for one or more first switches of the power converter; and
the second switch control signal is a second duty cycle for one or more second switches of the power converter.

22. The system of claim 21, wherein:
the one or more first switches comprise a first set of complementary switches; and
the one or more second switches comprise a second set of complementary switches.

23. The system of claim 22, the control circuitry further configured to dynamically modify the first duty cycle and the second duty cycle around the mode transition boundary to ensure one or more of:
a volt-second balance for the power converter across the mode transition boundary;
a capacitor charge balance for the power converter across the mode transition boundary; and
practically realizable switching times for switches of the power converter.

23. The system of claim 23, wherein dynamically modifying the first duty cycle and the second duty cycle comprises making non-linear modifications to the first duty cycle and the second duty cycle.

25. The system of claim 24, wherein dynamically modifying the first duty cycle and the second duty cycle comprises making step adjustments to the first duty cycle and the second duty cycle.

26. The system of claim 24, wherein dynamically modifying the first duty cycle and the second duty cycle results in introduction of an additional switching phase during a switching cycle of the power converter.

27. The system of claim 19, wherein:
the first pulse-width modulation carrier is piecewise linear; and
the second pulse-width modulation carrier is piecewise linear.

28. The system of claim 27, wherein:
the first pulse-width modulation carrier has step discontinuities; and
the second pulse-width modulation carrier has step discontinuities.

29. The system of claim 28, wherein:
the first pulse-width modulation carrier is a combination of a first set of multiple individual linear sections; and
the second pulse-width modulation carrier is a combination of a second set of multiple individual linear sections.

30. The system of claim 17, wherein the non-linearity is traversed while maintaining on and off times of switches of the power converter above a pre-determined threshold.

31. The system of claim 17, wherein the power converter is a buck-boost converter.

31. The system of claim 31, wherein the seamless transition occurs across the buck-boost mode boundary by introducing an additional switching phase to a switching cycle of the power converter.
